(19) United States
(12) Patent Application Publication
(10) Pub. No.: US 2016/0362338 A1
(43) Pub. Date: Dec. 15, 2016

(54) USE OF STEROLS AS AN ADDITIVE IN ASPHALT BINDER

(71) Applicants: ALM Holding Company, Onalaska, WI (US); Ergon Asphalt & Emulsions, Inc., Jackson, MS (US)

(72) Inventors: Gerald H. Reinke, La Crosse, WI (US); Gaylon L. Baumgardner, Arkadelphia, AR (US); Andrew Hanz, La Crosse, WI (US)

(21) Appl. No.: 15/179,858

(22) Filed: Jun. 10, 2016

Related U.S. Application Data
(60) Provisional application No. 62/173,781, filed on Jun. 10, 2015.

(51) Int. Cl. C04B 26/26; C04B 24/00; G01Q 60/24; C04B 24/02

(52) U.S. Cl. CPC C04B 26/26; C04B 24/02; C04B 24/001; G01Q 60/24

(57) ABSTRACT

Disclosed are asphalt binder compositions that include an anti-aging additive. The anti-aging additive improves various rheological properties. Methods of making such asphalt binder compositions and pavements are disclosed.

### CROSS-REFERENCE TO RELATED APPLICATIONS

This application claims priority to U.S. Provisional Application No. 62/173,781 filed Jun. 10, 2015, herein incorporated by reference in its entirety.

### BACKGROUND

Asphalt pavement is one of the most recycled materials in the world, finding uses when recycled in shoulders of paved surfaces and bridge abutments, as a gravel substitute on unpaved roads, and as a replacement for virgin aggregate and binder in new asphalt pavement. Typically, use of recycled asphalt pavement is limited to sub-surface pavement layers or to controlled amounts in asphalt base and surface layers. Such uses are limited in part because asphalt deteriorates with time, loses its flexibility, becomes oxidized and brittle, and tends to crack, particularly under stress or at low temperatures. These effects are primarily due to aging of the organic components of the asphalt, e.g., the bitumen-containing binder, particularly upon exposure to weather. The aged binder is also highly viscous. Consequently, reclaimed asphalt pavement has different properties than virgin asphalt and is difficult to process.

To reduce or retard the impact of asphalt aging on the long-range performance of mixtures, numerous materials have been investigated. For example, rejuvenators are marketed with a stated goal of reversing the aging that has taken place in recycled raw materials such as reclaimed asphalt pavement (RAP) and reclaimed asphalt shingles (RAS). It is unlikely that rejuvenation of asphalt can actually occur and the more likely scenario is that these additives may instead serve as softening agents for the virgin binders employed in mixtures containing RAP and/or RAS. In some instances, 10% or more by weight of these softening agents are added to the virgin binder when such mixtures are produced.

Aging can be assessed by measuring ΔTc, the difference between the Stiffness critical temperature and the creep critical temperature after aging. The use of these softening agents can produce a mixture with recovered binder properties that have acceptable values of ΔTc after extended mixture aging, but these acceptable binder properties after aging come at the cost of producing a mix that can be quite low in stiffness during the pavement's early life.

### SUMMARY

Disclosed are compositions and methods that may retard or otherwise overcome the effects of aging in recycled or reclaimed aged asphalt so as to preserve or retain some or all of the original properties of the virgin binder or virgin asphalt originally used when laying down the aged asphalt. In some embodiments, the disclosed compositions and methods may alter the aging rate of the total binder present in a mix containing virgin asphalt and high levels of RAP or RAS. The disclosed compositions and methods use a class of plant derived chemistry, the sterol class of compounds like those depicted in FIG. 1. While plant sterols do not contain the same number of condensed or partially unsaturated rings as asphaltenes, they do have the benefit of not being a linear or branched linear molecule.

In one embodiment, the present disclosure provides an asphalt binder composition comprising virgin asphalt binder, reclaimed asphalt binder material comprising reclaimed asphalt pavement (RAP), reclaimed asphalt shingles (RAS) or combinations of both, and an anti-aging additive in the range of 0.5 to 15 wt. % of the virgin binder, wherein the asphalt binder composition is free of cyclic organic compositions that contain esters or ester blends.

In one embodiment, the present disclosure provides an asphalt binder composition comprising virgin asphalt binder, reclaimed asphalt binder material comprising reclaimed asphalt pavement (RAP), reclaimed asphalt shingles (RAS) or combinations of both, and a restorative additive in the range of 0.5 to 15 wt. % of the virgin binder, wherein the asphalt binder composition is free of cyclic organic compositions that contain esters or ester blends.

In another embodiment, the present disclosure provides a method for slowing the aging or restoring aged asphalt binder comprising:
adding a restorative additive to an asphalt binder composition, wherein the asphalt binder composition comprises a binder, reclaimed asphalt binder material comprising reclaimed asphalt pavement (RAP), reclaimed asphalt shingles (RAS) or combinations of both, wherein the restorative additive is added in a range of 0.5 to 15 wt. % of the virgin asphalt binder.

In one embodiment, the present disclosure provides an asphalt paving composition comprising aggregate, virgin asphalt binder, reclaimed asphalt material comprising RAP, RAS or combinations of both, a triterpenoid, and a softening agent, wherein the asphalt paving composition preferably is free of cyclic organic esters, and has a triterpenoid content (e.g., a sterol content) of at least about 0.5, or at least about 1 wt. %, and at least about 5 wt. %, or up to about 8% or up about 10% or up to about 15 wt. % based on the virgin asphalt binder weight.

In another embodiment, the present disclosure provides an asphalt composition comprising virgin asphalt binder, reclaimed asphalt material comprising RAP, RAS or combinations of both, a triterpenoid, and a softening agent, wherein the asphalt composition preferably is free of cyclic organic esters, and has a sterol content of at least about 0.5, or at least about 1 wt. %, and at least about 5 wt. %, or up to about 8% or up about 10% or up to about 15 wt. % based on the virgin asphalt binder weight. % based on the virgin asphalt binder weight.

The triterpenoid in the disclosed embodiments may for example be a sterol, a stanol, a plant sterol, or a plant stanol.

In other embodiments, the present disclosure provides a method for retarding oxidative aging of the asphalt binder, which method comprises adding one or more triterpenoids (e.g., a triterpenoid blend) to a bituminous or asphalt composition, wherein the terpenoid(s) preferably do not contain an ester or an ester blend, and wherein the triterpenoid content in the composition is of at least about 0.5, or at least about 1 wt. %, and at least about 5 wt. %, or up to about 8% or up about 10% or up to about 15 wt. % based on the virgin asphalt binder weight, based on the virgin asphalt binder weight.

Exemplary embodiments of the present disclosure include, for example, i) asphalt binder compositions comprising RAS at a binder replacement level 1% and greater, ii) asphalt binder compositions comprising RAP at binder replacement levels 20% and greater, iii) asphalt binder compositions comprising RAP and RAS used in combination at binder replacement levels of 10% and greater RAP-derived binder and levels of 1% and greater RAS-derived binder, iv) asphalt binder compositions comprising asphalt binder extracted and recovered from post-consumer waste shingles at binder replacement levels of 3% by weight and greater, v) asphalt binder compositions comprising asphalt binder extracted from manufacture's waste shingles at binder replacement levels of 5% by weight and greater, vi) asphalt binder compositions comprising oxidized asphalts meeting ASTM specification D312 for Type II, Type III, Type IV and coating asphalt at binder replacement levels of 3% by weight and greater, vii) asphalt binder compositions comprising extracted and recovered RAP at binder replacement levels of 10% by weight and greater, viii) asphalt binder compositions comprising re-refined engine oil bottoms (REOB) at binder replacement levels of 1% and higher by weight, ix) asphalt binder compositions comprising paraffinic oils at binder replacement levels of 1% and higher by weight, x) asphalt paving compositions comprising aggregate mixed with REOB at binder replacement levels of 1% and higher by weight, and xi) asphalt paving compositions comprising aggregate mixed with paraffinic oils at binder replacement levels of 1% and higher by weight.

In still other embodiments, the disclosure provides a method for reusing reclaimed asphalt for asphalt pavement production, which method comprises the use of one or more triterpenoids (e.g., a triterpenoid blend) as an additive to a bituminous or asphalt mixture that preferably does not contain an ester or an ester blend, and wherein the triterpenoid additive is at least about 0.5 or at least about 1 wt. %, and up to about 3, up to about 10 or up to about 15 wt. %. based on the virgin asphalt weight.

Other embodiments comprise a method for applying a road pavement surface, which method employs an asphalt composition comprising aggregate, virgin asphalt binder, reclaimed asphalt material comprising RAP, RAS or combinations of both, a triterpenoid, and a softening agent, wherein the asphalt paving composition preferably is free of cyclic organic esters or ester blends, and has a sterol content of at least about 0.5 or at least about 1 wt. %, and up to about 15 or up to about 10 wt. % based on the virgin asphalt binder weight. In a further embodiment, the asphalt paving composition is prepared, mixed, applied to a base surface, and compacted.

### BRIEF DESCRIPTION OF DRAWINGS

FIG. 1 depicts a representative plant sterol structure e.g. beta-sitosterol.

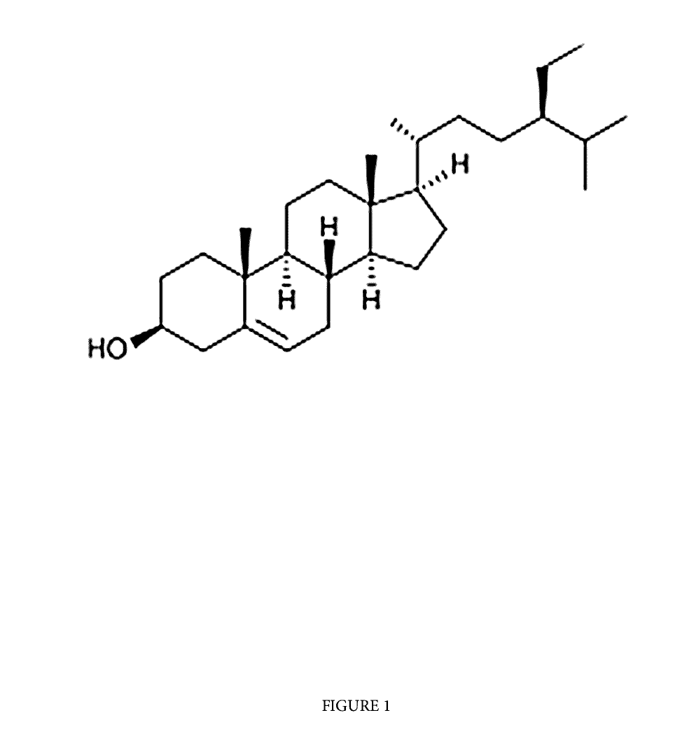

FIG. 2 is a graphical representation showing stiffness and creep temperature results for REOB Blends with sterols.

FIG. 3 shows exemplary plant sterols.

FIG. 4 is a graphical representation showing a change in ΔTc with level of sterol and binder aging.

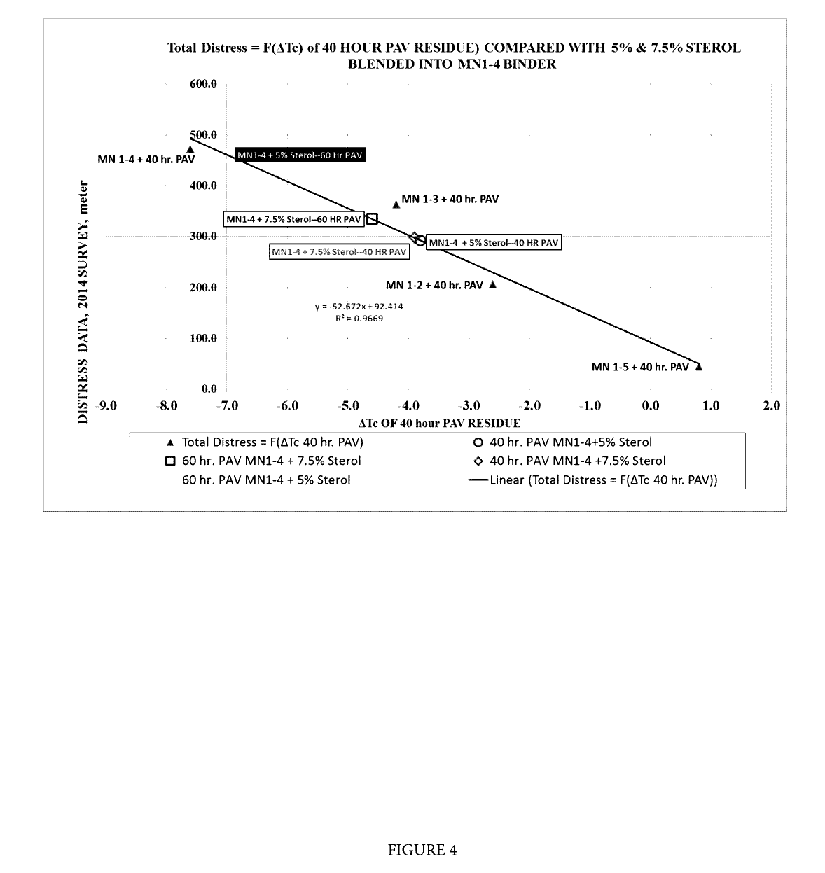

FIG. 5 is a graphical representation of R-value versus Colloidal Index for Mayan crude based Asphalto 64-22.

FIG. 6 is a graphical representation showing variation in ΔTc for Mayan crude Asphalto 64-22 and Canadian crude based PG 64-22.

FIG. 7 is a graphical representation of R-value versus Colloidal Index for Canadian crude based PG 64-22

FIG. 8 is a graphical representation of a comparison of R-Value versus Colloidal Index for Canadian crude based PG 64-22 with 0% sterol and Mayan crude based Asphalto 64-22 with 7.5% sterol.

FIG. 9 shows 3D AFM image of MN1-4 with 0% sterol after 60 hour PAV aging.

FIG. 10 shows 3D AFM IMAGE of MN1-4 with 5% sterol after 60 hour PAV aging.

FIG. 11 shows 3D AFM IMAGE of MN1-4 with 7.5% sterol after 60 hour PAV aging.

FIG. 12 is a graphical representation of Colloidal Index versus Percent AFM surface defects for 20, 40, 60 hour PAV residues for MN-14 Binder Blends with 5% and 7.5% Sterol.

FIG. 13 is a graphical representation of R-Value versus AFM surface defect area for all samples and for samples with the unaged binder data removed.

### LISTING & DESCRIPTION OF TABLES

TABLE 1 shows characteristics of bitumen in reclaimed asphalt binder sources relative to virgin binders.

TABLE 2 shows the high and low temperature properties of blends produced with virgin binders and bitumen recovered from post-consumer waste shingles after different periods of aging.

TABLE 3 shows results of sterols on the high and low temperature properties of aged asphalt binder blend #1.

TABLE 4 shows results of sterols on the high and low temperature properties of aged asphalt binder blend # 2.

TABLE 5 shows results for REOB Blends with sterols.

TABLE 6 shows comparison of total distress data versus 40 hour PAV ΔTc data for CTH 112-test sections and use of 5% and 7.5% sterol blended into MN1-4 binder and aged for 40 and 60 hours in the PAV.

TABLE 7 shows high and low temperature properties of aged binders with sterols compared with bio-derived oils.

TABLE 8 shows ΔTc results of aged binders and recovered binders with sterols compared with bio-derived oils.

TABLE 9 shows the low temperature Stiffness Critical grades and the low temperature m-value Critical grades for the binders recovered from the four mixtures.

TABLE 10 shows R-Value, Colloidal Index and Iatroscan results for Mayan Crude Based Asphalto 64-22.

TABLE 11 shows S-Critical, m-Critical and ΔTc Results for Mayan Crude based Asphalto 64-22.

TABLE 12 shows R-Value, Colloidal Index and Iatroscan results for PG 64-22.

TABLE 13 shows S-Critical, m-Critical and ΔTc Results for Canadian Crude based PG 64-22.

TABLE 14 shows AFM surface roughness and surface defect data for MN-14 Binder at 0%, 5% and 7.5% sterol loading.

Table 15 shows roughness analysis for various aging conditions.

TABLE 16 shows comparison of PG 52-34 with 5% sterol, 2.5% of a bio derived oil and 20% binder recovered from tear off shingles and a sample of PG 52-34 with 5% Sterol and no other additives.

### DETAILED DESCRIPTION

The disclosed asphalt compositions contain anti-aging (viz., age reducing or aging retarding) additives that help in the preservation, recycling and reuse of asphalt compositions. The asphalt compositions preferably are free of cyclic organic compositions that contain esters or ester blends. The disclosed compositions have particular value for the renewal of reclaimed asphalt, and especially RAP.

The disclosed asphalt compositions provide for recycled asphalt (e.g. RAP or RAS the binders of which may have improved physical and rheological characteristics such as stiffness, effective temperature range, and low temperature properties. Some embodiments provide for the use of binder extracted from RAS in asphalt blends. Certain embodiments provide for the addition of a additive to minimize potential detrimental low-temperature effects of recycled asphalt while allowing for higher stiffness at high temperatures.

Headings are provided herein solely for ease of reading and should not be interpreted as limiting.

### Abbreviations, Acronyms & Definitions

“RTFO” refers to a Rolling Thin Film Oven Test. This is a test used for simulating the short-term aging of asphalt binders as described in ASTM D2872-12e1, Standard Test Method for Effect of Heat and Air on a Moving Film of Asphalt (Rolling Thin-Film Oven Test).

“PAV” refers to a Pressurized Aging Vessel test. The PAV test simulates accelerated aging of asphalt using a pressurized aging vessel as described in ASTM D6521-13, Standard Practice for Accelerated Aging of Asphalt Binder Using a Pressurized Aging Vessel (PAV).

“Asphalt Binder” refers to a binder material including bitumen and optionally other components that is suitable for mixing with aggregate to make a paving mix. Depending on local usage, the term “bitumen” may be used interchangeably with or in place of the term “asphalt” or “binder”.

The terms “asphalt paving mixture”, “asphalt mix” and “mix” refer to an uncompacted mixture of asphalt and aggregate. Depending on local usage, the terms “bitumen mix” or “bituminous mixture” may be used interchangeably with or in place of the terms “asphalt paving mixture”, “asphalt mix” or “mix”.

“Asphalt pavement” refers to a compacted mixture of asphalt and aggregate.

The terms “Reclaimed asphalt” and “recycled asphalt” include RAP, RAS, and reclaimed asphalt from plant waste, roofing felt, and other products or applications.

The terms “reclaimed asphalt pavement” and “RAP” refer to asphalt that has been removed or excavated from a previously used road or pavement or other similar structure, and processed for reuse by any of a variety of well-known methods, including milling, ripping, breaking, crushing, or pulverizing.

The terms “reclaimed asphalt shingles” and “RAS” refer to shingles from sources including roof tear-off and manufacture's waste asphalt shingles and post-consumer waste.

The terms “aggregate” and “construction aggregate” refer to particulate mineral material such as sand, gravel, crushed stone, crushed rock and slag useful in paving and pavement applications.

“Bitumen” refers to a class of black or dark-colored (solid, semisolid, or viscous) cementitious substances, natural or manufactured, composed principally of high molecular weight hydrocarbons, of which asphalts, tars, pitches, and asphaltines are typical.

The terms “Aged asphalt binder” refer to asphalt or binder that is present in or is recovered from reclaimed asphalt. Aged binder has high viscosity compared with that of virgin asphalt or virgin bitumen as a result of aging and exposure to outdoor weather. The term “aged binder” also refers to virgin asphalt or virgin binder that has been aged using the laboratory aging test methods described herein (e.g. RTFO and PAV). “Aged binder” may also refer to hard, poor-quality, or out-of-specification virgin binders that could benefit from addition of the disclosed additive particularly virgin binders having a ring-and-ball softening point greater than 65° C. by EN 1427 and a penetration value at 25° C. by EN 1426 less than or equal to 12 dmm.

“Softening agent” refers to additives that ease (or facilitate) the mixing and incorporation of a recycled asphalt into fresh bitumen or into an asphalt mix, during an asphalt mix production process.

“Anti-aging additive” refers to a composition or mixture that is combined with aged binder (e.g. reclaimed asphalt) to restore or revitalize the aged binder and provide some or all of the original properties of virgin asphalt or virgin binder.

“Neat” or “Virgin” binders are binders not used, recycled such as Performance Grade binders.

All weights, parts and percentages are based on weight unless otherwise specified.

### Binders

Current bituminous paving practices involve the use of high percentages of Reclaimed Asphalt Pavement (RAP) and Reclaimed Asphalt Shingles (RAS) as components in the bituminous mixtures being paved. Typically RAP concentrations can be as high as 50% and RAS concentrations can be as high as 6% by weight. The typical bitumen content of RAP is in the range of 5-6% by weight and the typical bitumen content of RAS is in the range of 20-25% by weight. Consequently, a bituminous mixture containing 50% by weight of RAP will contain 2.5% to 3% RAP bitumen contributed to the final bituminous mixture and a bituminous mixture containing 6% RAS by weight will contain 1.2% to 1.5% RAS bitumen contributed to the final bituminous mixture. In many instances RAP and RAS recycled additives are combined in bituminous mixtures; for example 20% to 30% RAP and 5% to 6% RAS can be incorporated into a bituminous mixture. Based on the typical the bitumen contents of RAP and RAS, bituminous mixtures containing 20% to 30% RAP and 5% to 6% RAS can result in 2% binder coming from the RAP and RAS combination to as much as 3.3% binder being derived from the RAP and RAS combination. Since a typical bituminous paving mixture will contain about 5.5% total bitumen there can be about 36% to as much as 60% of the total bitumen in the bituminous mixture being replaced from these recycled sources.

Characteristics of bitumen in these reclaimed sources relative to virgin binders used in bituminous mixtures are shown in Table 1.

Table 2 shows the high and low temperature properties of blends produced with virgin binders and bitumen recovered from post-consumer waste shingles after different periods of aging. Also shown in Table 2 are high and low temperature properties of mixtures containing RAP and RAS. Some of these mixtures have undergone extended laboratory aging and some of which are from field cores. Tables 1 and 2 are meant to show the impact of incorporating high binder replacement levels of recycled materials, especially those derived from post-consumer waste shingles. The data are by no means exhaustive but do provide a basis of support for the necessity of incorporating additives into bitumen and bituminous mixtures that can mitigate the impact of the bitumen derived from these recycled components and also retard their impact on further oxidative aging of the total bitumen in the final mixture. Note the last three rows of Table 2, which shows that the further away from the air mixture interface the lesser is the impact on the parameter labeled ΔTc. ΔTc is defined as the difference between the stiffness critical temperature and the creep critical temperature. This parameter may be used to assess aging.

Research published in 2011 showed, based on recovered binder data from field cores that when the ΔTc parameter, falls below −3° C. there is a danger of non-load related mixture cracking. Specifically a difference of −4° C. was construed as a warning limit and a difference of −5° C. was construed as a potential failure point.

Recently studies and reported at two Federal Highway Administration Expert Task Group meetings have shown a correlation between ΔTc values of binders recovered from field test projects and severity of pavement distress related to fatigue cracking. Additionally, it has been shown that when binders used to construct these field test projects were subjected to 40 hours of PAV aging the ΔTc values showed a correlation to pavement distress related to fatigue cracking.

It is therefore desirable to obtain bituminous mixtures with bitumen materials that have a reduced susceptibility to the development of excessively negative values of ΔTc.

The data in Table 1 show typical virgin binders produced at refineries can maintain a ΔTc of greater than −3° C. after 40 hours of PAV aging. Further, the data in Table 1 show that binder recovered from RAP can have ΔTc values of less than −4° C. which means that evaluation of the impact of high levels of RAP in new bituminous mixtures should be evaluated. Further, the extremely negative values of ΔTc for RAS recovered binders require additional scrutiny as to the overall impact of RAS incorporation into bituminous mixtures.

Table 2 shows that it is possible to extend this concept to mixture behavior by laboratory aging of the bituminous mixtures followed by recovery of the binder from the mixtures and determination of the ΔTc of that recovered binder. The long term aging protocol for bituminous mixtures in AASHTO R30 specifies compacted mix aging for five days at 85° C. Some research studies have extended the aging time to ten days to investigate extended aging. Recently, aging loose bituminous mixes at 135° C. for 12 and 24 hours and in some instances even for greater time periods have been presented as alternatives to compacted mix aging. The goal of these aging protocols is to produce rapid aging of the binders in these mixtures to the equivalence of field aging representative of more than five years in service and more desirably eight to 10 years in service. It has been shown for mixtures in service for eight years that the ΔTc of the recovered binders from the top ½ inch of pavement was more severe than 12 hours aging at 135° C. but less severe than 24 hours aging at 135° C.3,4

The data in the first two rows of Table 2 show why long-term aging of mixtures containing recycled products is important. The binder recovered from the unaged mix (row 1) exhibited a ΔTc of −1.7° C., whereas the binder recovered from the 5 day aged mix exhibited a ΔTc of −4.6° C.

In some embodiments, recycled or reclaimed asphalt include reclaimed asphalt pavement (RAP), reclaimed asphalt singles (RAS) such as post-consumer waste shingles.

### Anti-Aging Additives

The disclosed anti-aging additives preferably are used to alter (e.g., retard) an asphalt binder aging rate, or to restore and renew a binder (e.g. aged binder).

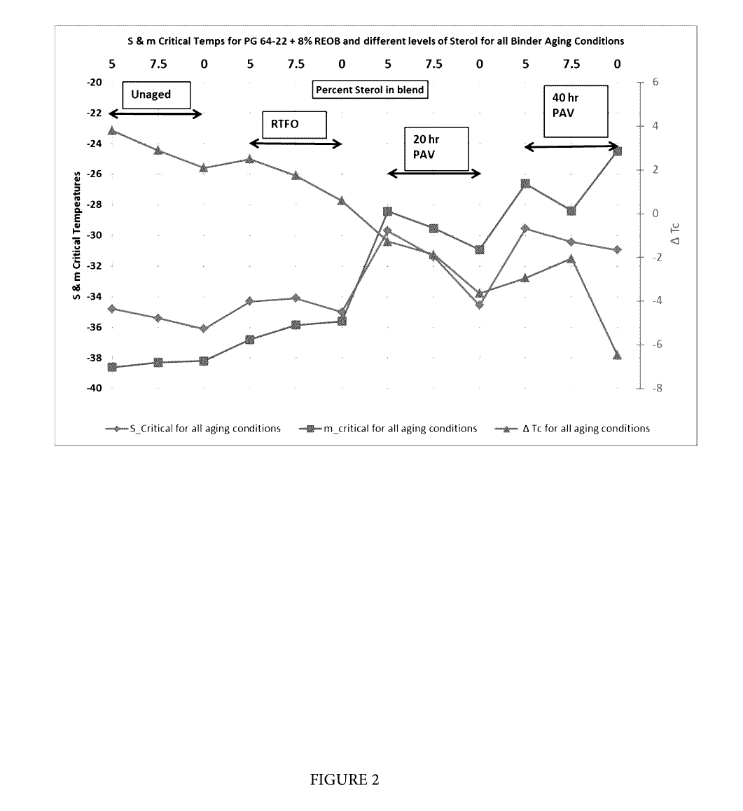

In some embodiments, the additive belongs to the class of triterpenoids, and in particular to sterols or stanols. The disclosed additive (e.g. a triterpenoid) can effectively work with asphaltenes. Asphaltenes, as diagramed in FIG. 2, include extensive condensed ring systems with some level of unsaturation. The asphaltene content of typical binders can range from less than 10% to more than 20%. Asphaltenes are sometimes described as materials that are insoluble in n-heptane. An exact structure is unknown and based on the performance behavior of different binders it is unlikely that the asphaltene structure in any two binders is the same. Asphaltenes give a binder its color and stiffness and they increase in content as the binder ages. Consequently, the addition of RAP or RAS causes the asphaltene content to increase. Increasing asphaltene content along with other products of oxidation such as carbonyls and sulfoxides are responsible for the stiffening of bituminous mixtures and their ultimate failure. By their very chemical nature asphaltenes are not readily soluble in aliphatic chemicals. Aromatic hydrocarbons will readily dissolve asphaltenes and aromatic process oils have been used in recycled mixtures. However these oils may contain polynuclear aromatic compounds including listed potential carcinogens and therefore are not desirable additives. Most plant based oils are straight or branched chain hydrocarbons with some level of unsaturation and therefore are not as effective at retarding aging as they are at softening the overall binders in a mixture.

Titerpenoids are a major group of plant natural products that include sterols, triterpene saponins, and related structures. Triterpenoids can be of natural or synthetic origin. Typically they are obtained by extraction from plant material. Extraction processes for the isolation of triterpenoids are described e.g. in the international applications WO 01/72315 A1 and WO 2004/016336 A1, the disclosures of which are each incorporated herein by reference in their entirety.

The triterpenoids include plant sterols and plant stanols. The disclosed triterpenoids refer to the non-esterified forms of any of the plant sterols mentioned herein.

Exemplary plant sterols include campesterol, stigasterol, stigmasterol, β-sitosterol, Δ5-avenosterol, Δ7-stigasterol, Δ7-avenosterol, brassicasterol or mixtures thereof. In some embodiments, the anti-aging additive is β-sitosterol. In other embodiments, the anti-aging additive is a mixture of sterols. Commercially available sterols include sterols available from MP Biomedicals (Catalog No. 02102886) referred to as beta-Sitosterol (beta-Sitosterol ˜40-60%; campesterol ˜20-40%; Stigmasterol˜5%). Exemplary plant sterols also include modified or unmodified natural products containing significant quantities of sterols, such as cashew nut shell liquid which may for example include 20% or more sterol content.

The plant sterol may for example range from about 0.5 to about 15 wt. %, or about 1 to about 10 wt. %, about 1 to about 3 wt. % of the virgin binder in an asphalt paving.

In some embodiments, the anti-aging additive can alter or restore rheological properties in aged binders or recycled binders. In other embodiments, the additive when used in an asphalt or asphalt pavement maintains a ΔTc value above −3° C.

### Softening Agents & Other Additives

Softening agents that may be used in binders include Re-refined Engine Oil Bottoms (REOB). REOB is a low cost softening additive and asphalt extender obtained from the residual material remaining after the distillation of waste engine oil either under vacuum or at atmospheric pressure conditions. The distilled fraction from the rerefining process is reprocessed into new lubricating oil for vehicles, but the bottoms do not have an available market due to the presence of metals and other particulates from internal combustion engines. Also these bottoms contain paraffinic hydrocarbons and additives incorporated into the original lubricating oil. For many years these bottoms were used by some companies as an asphalt extender, but the usage was localized.

Greater amounts of these re-refined engine oil bottoms are being produced and sold into the asphalt binder market. The use of REOB may provide mixtures having ΔTc values of −4° C. or lower with consequent poor performance in pavements. When amounts of REOB are added to asphalt at levels as low as 5% by weight the resulting ΔTc after 40 hr. PAV aging can be −5° C. or lower (e.g. more negative). Recovered binders from field mixes shown to contain REOB by means of metals testing have shown greater distress than field mixtures of the same age and the same aggregate and paved at the same time but not containing REOB.

The disclosed anti-aging additives (e.g. the sterols and stanols) can mitigate the impact of REOB (for example as tested on 40 hr. PAV) on ΔTc as well as retard the aging rate of the recycled asphalt.

The disclosed anti-aging additive can also be used to mitigate the impact of other softening agents. These other softening agents include virgin lubricating oils (such as MOBIL 1 and HAVOLINE10W40), virgin paraffin base oils, and untreated or non-rerefined waste drain oils.

The asphalt composition may contain other components in addition to the disclosed additive. Such other components can include elastomers, non-bituminous binders, adhesion promoters, softening agents, rejuvenating agents and other suitable components.

Useful elastomers include, for example, ethylene-vinyl acetate copolymers, polybutadienes, ethylene-propylene copolymers, ethylene-propylene-diene terpolymers, butadiene-styrene block copolymers, styrene-butadiene-styrene (SBS) block terpolymers, isoprene-styrene block copolymers and styrene-isoprene-styrene (SIS) block terpolymers, chloroprene polymers (e.g., neoprenes) and the like. Cured elastomer additives may include ground tire rubber materials.

Conventional rejuvenating agents are classified into types such as RA-1, RA-5, RA-25, and RA-75 as defined by ASTM D4552. Rejuvenating agents for use in the disclosed asphalt compositions may for example resemble the maltene fraction of asphalt such as an RA-1 rejuvenating agent, an RA-5 rejuvenating agent, or mixtures thereof. Exemplary rejuvenating agents are available from Holly Frontier under their HYDROLENE™ brand asphalt oils, from American Refining Group, Inc. under their KENDEX™ brand or from Tricor Refining, LLC under their Golden Bear Preservation Products RECLAMITE™ brand. Asphalt oils meeting ASTM standard D4552, and classified as RA-1 are suitable for harder asphalts, such as PG 64. RA-5, RA-25 and RA-75 oils may also be used with lower viscosity asphalts, such as PG 52. The rejuvenation agents can also include recycling agents that are rich in aromatics and resins, with small amounts of saturates.

The disclosed asphalt compositions can be characterized according to ASTM specifications and test methods, in addition to many standard tests. For example, the disclosed compositions can be characterized using rheological tests (viz., dynamic shear rheometer, rotational viscosity, and bending beam).

At low temperatures (e.g., −10° C.), road surfaces need cracking resistance. Under ambient conditions, stiffness and fatigue properties are important. At elevated temperature, roads need to resist rutting when the asphalt becomes too soft. Criteria have been established by the asphalt industry to identify rheological properties of a binder that correlate with likely paved road surface performance over the three common sets of temperature conditions.

In one embodiment, the binder includes a blend of binders. In certain embodiments, the binder blend includes virgin binder and binder extracted from reclaimed asphalt. For example, the binder extracted from RAS material may be extracted from manufacturer asphalt shingle waste, from consumer asphalt shingle waste, or from a mixture of binders extracted from manufacturer and consumer asphalt shingle waste. In certain embodiments, a binder blend may include from about 60 wt % to about 95 wt % of virgin binder and from about 5 wt % to about 40 wt % of binder extracted from reclaimed asphalt such as RAS. In certain embodiments, the binder blend includes the addition of an anti-aging additive from about 0.5 wt % to about 15.0 wt % of the virgin asphalt. In certain embodiments, the binder blend can include the addition of from about 0.2 wt % to about 1.0 wt % anti-aging additive. The anti-aging additive has been shown to improve high and low temperature properties and PG grading for both low and high temperature ends of RAS-containing asphalt binder blends.

Asphalt compositions can be prepared by applying mechanical or thermal convection. In one aspect a method of preparing an asphalt composition involves mixing the asphalt with an anti-aging additive in addition to RAS or RAP at a temperature of from about 100° C. to about 250° C. In certain embodiments, the asphalt is mixed with anti-aging additive and RAS at a temperature of from about 125° C. to about 175° C., or 180 to 205. In some embodiments, the asphalt composition is mixed with asphalt, RAS, anti-aging additive and softening agent. In still other embodiments, the asphalt composition is mixed with asphalt, RAS, anti-aging additive and aggregate. The aggregate may be any of those known to be useful in the preparation of asphalt mixes such as, but not limited to, limestone, granite, and trap rock. The order of mixing the components of the asphalt composition is not limited. The composition may be prepared by mixing the binder with anti-aging additive followed by the addition of RAS and, in some cases the aggregate. The binder may also be mixed first with RAS, followed by addition of anti-aging additive and the aggregate. In yet another embodiment, the binder, anti-aging additive, and RAS are added together at the same time, followed by the addition of the aggregate. One of skill in the art will recognize that other sequences of adding and mixing components are possible.

To determine the ΔTc parameter, a 4 mm dynamic shear rheometer (DSR) test procedure and data analysis methodology was used that was developed by Western Research Institute (Sui, C., Farrar, M., Tuminello, W., Turner, T., A New Technique for Measuring low-temperature Properties of Asphalt Binders with Small Amounts of Material, Transportation Research Record: No 1681, TRB 2010. See also Sui, C., Farrar, M. J., Harnsberger, P. M., Tuminello, W. H., Turner, T. F., New Low Temperature Performance Grading Method Using 4 mm Parallel Plates on a Dynamic Shear Rheometer. TRB Preprint CD, 2011).

### Example 1

To investigate the efficacy of the anti-aging additive, two binder blends were produced and aged for 20 and 40 hours in the PAV (Pressured aging vessel) following ASTM D65217.

Blends were produced by mixing the components with a low shear Lightning mixer in a 1 gallon can at a temperature of 187.8° C.-204° C. (370-400° F.) for approximately 30 minutes.

Blend #1 consisted of 72.5% of a conventional PG 58-28 binder, 20% binder recovered from post-consumer waste shingles obtained from Recovery Technology Solutions (RTS), Shakopee, Minn. and 7.5% of mixed sterols obtained from MP Biomedicals (Catalog No. 02102886) referred to as beta-Sitosterol (beta-Sitosterol ˜40-60%; campesterol ˜20-40%; Stigmasterol˜5%).

The results show that with the use of the mixed sterols, the impact previously seen with the use of shingles was reduced and that after 40 hours of PAV aging the ΔTc was −1.0° C. The PG 58-28, sterol, shingle binder blend in Table 3 exhibited a ΔTc of −1.0 after 40 hours PAV aging whereas the virgin PG 58-28 shown in Table 1 exhibited a ΔTc of −2.9° C. The use of the sterol anti-aging additive with the shingles improved the ΔTc property relative to virgin binder without the anti-aging additive.

Blend #2 consisted of 75% of a conventional PG 52-34 binder, 20% binder recovered from post-consumer waste shingles obtained from Recovery Technology Solutions (RTS), Shakopee, Minn. and 5% mixed sterols obtained from VWR Scientific. The results of those tests are shown in Table 4.

Table 4 showed that after the 40 hr. PAV the ΔTc ws −1.9° C. Also shown in the last row of Table 4 are the 20 hr. and 40 hr. PAV results for a blend of 80% PG 52-34 plus 20% recovered shingle binder from manufacturers scrap obtained from Recovery Technology Solutions (RTS), Shakopee, Minn. These data show the ΔTc for the 20 hr. PAV is −1.2° C. and for the 40 hr. PAV is −4.4° C. Typically binder recovered from manufacturer's scrap is less stiff than binder from post-consumer waste. These data show that the Stiffness critical temperature for the blend made with the manufacturer's scrap has better low temperature properties than does the blend made with the post-consumer waste at both the 20 hr. PAV and 40 hr. PAV condition. However, the creep critical temperature for both the post-consumer waste and the manufacturer's scrap are nearly identical, the net result being that the ΔTc for the sterol containing sample is improved relative to the sample with no sterol additive.

### Example 2

To evaluate whether the use of mixed sterols could mitigate the excessive ΔTc results observed with REOB, three binder blends were evaluated. The blends were produced by mixing in a 1 quart can with a low shear Lightning mixer at a temperature of 300-325° F. for about 30 min. The REOB blends require less heat compared to the blends with recovered shingle binder as in Example 1.

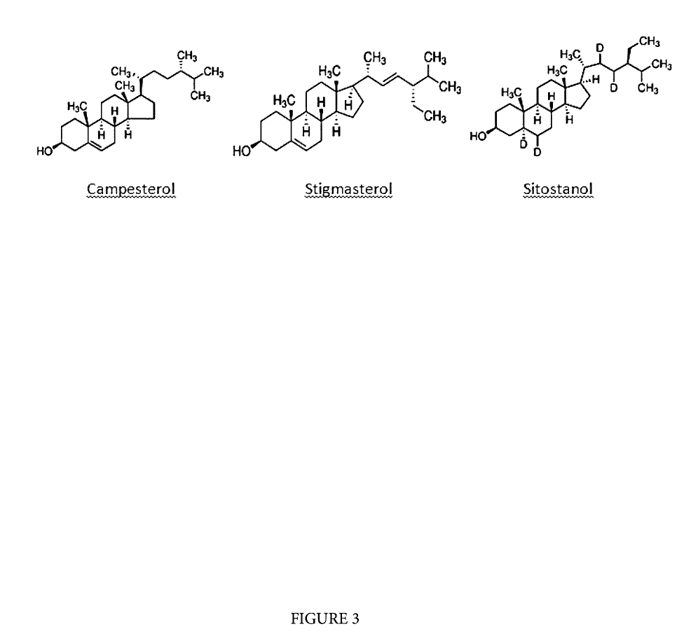

The results are shown in Table 5 and plotted in FIG. 3.

As the binder aged, the ΔTc value for the blend with zero percent sterol exhibited the lowest value ΔTc. At 40 hr. PAV aging the ΔTc result for both the 5% and 7.5% sterol blends were greater than −3.0° C. while the zero percent sterol blend had a ΔTc value of −5.2° C.

### Example 3

To evaluate whether the use of mixed sterols could mitigate the excessive ΔTc results observed with REOB in binders, three blends were evaluated. The blends were produced by mixing in a 1 quart can with a low shear Lightning mixer at a temperature of 300-325° F. for about 30 min. The REOB blends require less heat compared to the blends with recovered shingle binder as in Example 1. The mixed sterols used are the same as those described in Example 1.

Using the MN1-4 binder blends were produced using 5% and 7.5% sterol and aged for 20, 40 and 60 hours of PAV conditioning. Low temperature properties and ΔTc values were measured using the 4 mm DSR test procedure for an unaged, RTFO, 20, 40 and 60 hour PAV aging conditions.

Table 6 shows the comparison of total distress data versus 40 hour PAV ΔTc data for CTH 112-test sections and use of 5% and 7.5% sterol blended into MN1-4 binder and aged for 40 and 60 hours in the PAV.

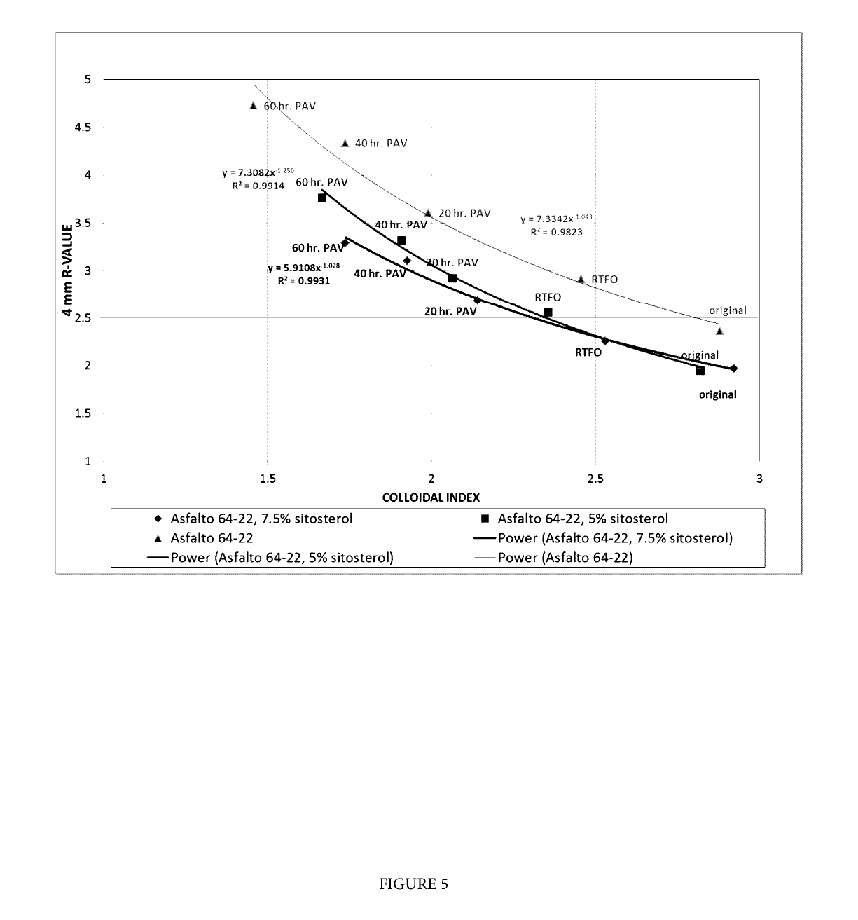

The data in Table 6 are also plotted in FIG. 5.

Samples of MN1-4 treated with 5% and 7.5% sterol and aged for 40 and 60 hours in the PAV all exhibited ΔTc values greater than (less negative) than the 40 hour PAV of untreated MN1-4. In a direct comparison of the ΔTc values for 40 hour PAV residues the sterol treated MN1-4 had values approximately half of the untreated MN1-4 binder.

### Example 4

To further evaluate the role of sterols with reclaimed asphalt binder singles, four blends were evaluated: a control binder and two binders blended with commercial bio-derived oils that are promoted as rejuvenating additives for use with high levels of RAP and/or RAS. The four binders were:

1. A control binder PG 52-34 with no additive

2. PG 52-34+5% mixed sterols

3. PG 58-28+5% EVOFLEX PC2106 marketed by Ingevity

4. PG 58-28+5% RS1100 marketed by Arizona Chemical

The blends were produced by mixing in a one quart can with a low shear Lightning mixer at a temperature of 148.9° C.-162.8° C. (300-325° F.) for about 30 min.

The blends that were produced so that the high temperature PG grade of all four binders would be approximately the same. Because the use of 5% bio-derived oil typically reduces the high temperature PG grade by 6° C. or more a PG 58-28 binder was used with the PC2106 and the RS1100.

After producing the blends, the high temperature PG grade of the four binders was determined. Also 4 mm DSR testing was performed on all four binders in the unaged, RTFO aged condition, 20 hour PAV and 40 hour PAV aged condition for determination of the low temperature stiffness critical temperature grade (S Critical) and low temperature m-value critical temperature grade (m Critical) values and determination of the S Critical grade—the m Critical grade to obtain the value of ΔTc.

Further each unaged binder was mixed with a typical dense graded aggregate suitable for paving a road designed to carry a designed traffic life of 3 million Equivalent Single Axel Loads (ESALs) with the addition of 5% RAS. The 5% RAS contained sufficient binder to provide approximately 20% binder replacement in the mixture. Such a level of RAS in paving mixtures is currently a well-accepted practice in the bituminous paving industry. Each 3000 gram mixture was produced by blending 5% of the RAS with 95% of the 12.5 mm nominal maximum sized aggregate. The total binder content required for the mix was 5.7% but since 20% of the binder content came from the RAS, only 4.56% of each of the binder blends was added by weight of the total mix.

The mixes were produced in a bucket mixer at a temperature of 162.8° C. (325° F.) and then each was placed in a pan in a layer 18 inches by 12 inches by 2.5 inches thick. The mix was not compacted but placed in loose condition in the pan. The pans were placed in a Blue M model 166 forced draft oven at 135° C. (275° F.) and held at that temperature for 24 hours. After this period, the mixes were removed, allowed to cool to room temperature and then the binder was extracted from the mixtures using toluene and recovered using a Buchi rotary evaporator following ASTM D7906-14, Standard Practice for Recovery of Asphalt binder from Solution Using Toluene and the Rotary Evaporator.

Following recovery the 4 mm DSR test was performed. The high temperature PG grade of each binder and the low temperature properties as determined from the 4 mm DSR test after 20 hours of PAV aging are shown in Table 7.

The data in Table 7 shows that although two different starting binders were used once the blends were produced with the bio-derived oils, the high temperature PG grades were nearly the same and in fact the bio-derived oil blends were a little lower in stiffness. Conventional low temperature PG grading is determined on the binder after the 20 hour PAV aging procedure.

The low temperature PG grade data in Table 7 showed that all four binders met a PG grade of −34. Therefore prior to producing the bituminous mixtures with the 5% RAS and prior to the 24 hour aging, the mixtures had been made with binders of very similar high and low PG grade values.

The ΔTc properties of the four binders at the unaged, RTFO, 20 hour PAV, 40 hour PAV and the recovered binder from the 24 hour aged mixtures is shown in Table 8.

The data in Table 8 shows that through 40 hours of PAV aging there is little difference between the ΔTc properties of the four binders. However once the RAS containing mixture was produced, aged and then the binder recovered and tested it was clear that the sterol-blended binder resisted the aging and loss of binder relaxation that is characteristic of aged RAS mixtures.

Table 9 shows the low temperature Stiffness Critical grades and the low temperature m-value Critical grades for the binders recovered from the four mixtures. Table 9 showed that the 24 hour, 135° C. (275° F.) conditioning had the greatest impact on the m-value Critical Temperature value when compared to the Stiffness and m-value critical data shown in Table 7.

Also shown in Table 9 is the high temperature PG grade of the recovered binders from the four mixtures. The high temperature grade of the sterol blend is 10° C. to 17° C. below the high temperature grades of the other recovered binders, which amounts to 1.5 and nearly 3 full PG grade changes between the sterol blended binder and the other binder blends. As for the low temperature binder grades the stiffness critical values have increased by 3.7° C. to as much as 8.9° C., but the m-value critical values have increased by 13.6° C. (for the Sterol blend) to approximately 23° C. for the two bio-derived oil blends. It is clear the relaxation properties are impacted more substantially by the presence of the RAS combined with the mixture aging. It is also clear that the sterol containing mixture was impacted the least at both the high and low temperature properties compared to the other binders.

### Example 5

A sample of PG 64-22 asphalt binder from Pemex Refinery in Mexico using Mayan crude was found to have very poor aging properties when subjected to up to 60 hours of PAV aging as compared to a PG 64-22 obtained from a domestic US refinery using Canadian crude. Blends were produced by adding 5% and 7.5% mixed Sterols to the Mexican asphalt binder designated as Asphalto 64-22 and similar blends were produced using the domestically produced PG 64-22. In total 6 binder samples were evaluated. The blends were produced as described in Example 1 and the sterols used are the same as were described in Example 1.

1. A control sample of Asphalto 64-22 with no additive

2. Asphalto 64-22+5% mixed sterols

3. Asphalto 64-22+7.5% mixed sterols

4. A control sample of domestic PG 64-22 with no additive

5. Domestic PG 64-22+5% mixed sterols

6. Domestic PG 64-22+7.5% mixed sterols

Binders were tested in unaged, RTFO, 20 hour PAV, 40 hour PAV and 60 hour PAV aged condition. High and low temperature PG grades were determined. The low temperature results were obtained using the 4 mm DSR procedure previously described. High temperature grade was determined following ASTM D7175. Also determined was the ΔTc result at all aging conditions based on the 4 mm DSR data. Also calculated was the Rheological Index also known as R-Value from the 4 mm DSR data. Compositional data from binders in all aged conditions was measured using the Iatroscan procedure and the Colloidal Index calculated from the data. The data for all tests are summarized in Tables 10 through 13.

As a general trend, as asphalt binders age the R-value increases because of decreased ability to relax stress and the Colloidal Index decreases because the amount of asphaltenes increase while saturates remain mostly unchanged and the cyclics decrease with only modest increases in resins. Inspection of the data in Table 10 showed that as the Asphalto 64-22 binder samples with 0%, 5% and 7.5% sterol is successively more aged the R-Value increases and the Colloidal Index decreases. Table 11 showed a steady decrease in the value of ΔTc for each sterol dosage level, but much less of a decrease for the 5% and 7.5% blends.

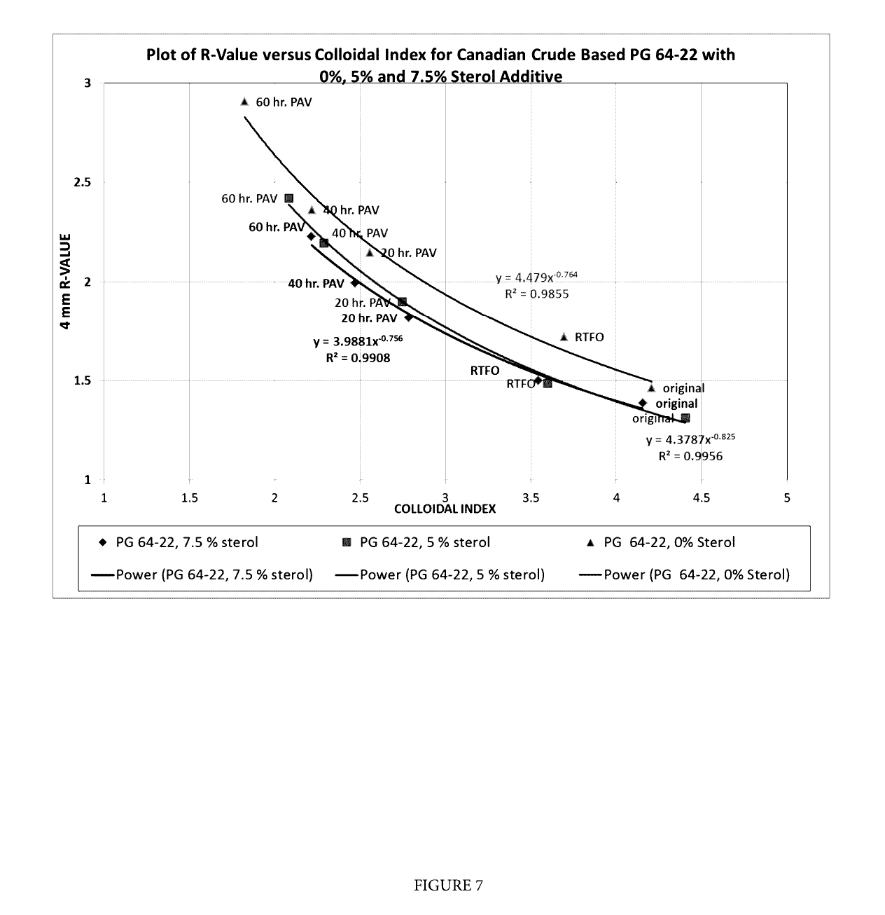

These trends were more easily seen in FIGS. 5, 6 and 7. The data plotted in FIG. 5 showed the relationship between R-Value and Colloidal Index plots sustainably higher in R-Value for every value of Colloidal Index for the 0% sterol blend. The 5% and 7.5% sterol blends have R-Values that are 0.5 or more lower than the corresponding R-Values for the 0% sterol blend. The data also showed that after 20 hours of PAV aging there was a decrease in the R-value for the 7.5% sterol blend compared to the 5% sterol blend thus indicating that there was a dose response effect with the sterol additive for the Asphalto 64-22 binder. Since the colloidal index was a chemical constituent determination and the R-Value was rheological determination the high level of correlation between these two parameters suggests that the impact of the sterol has chemical compositional as well as a rheological basis.

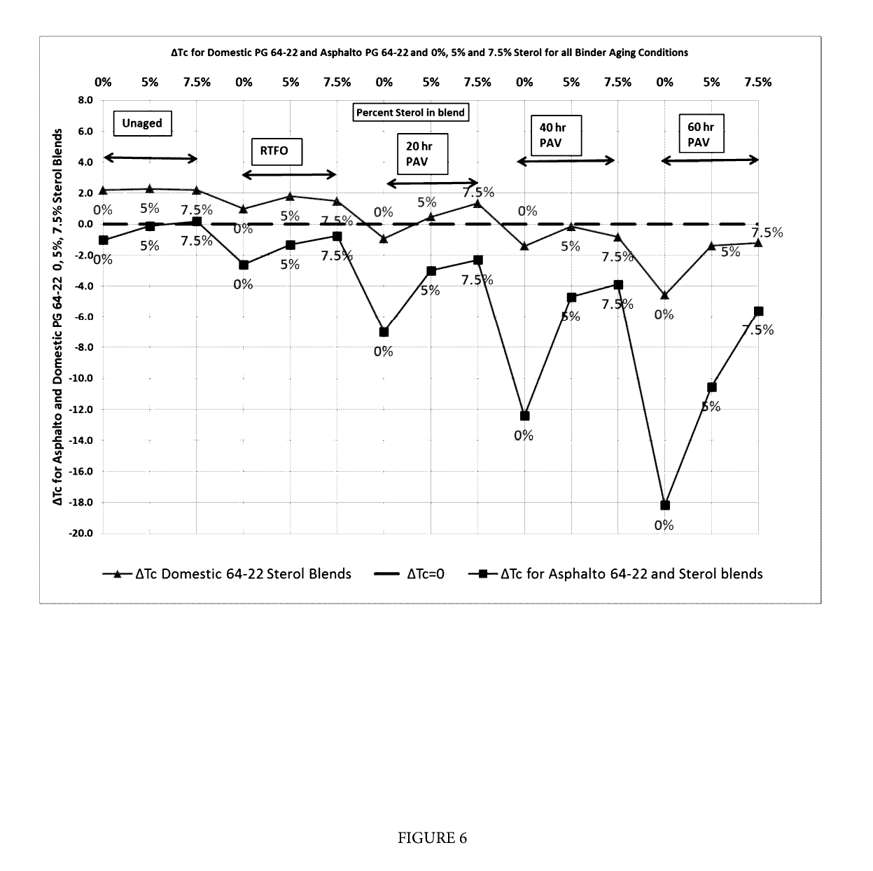

FIG. 6 is a plot of the ΔTc data obtained from the 4 mm DSR test for the unaged, RTFO, 20 hour PAV, 40 hour PAV and 60 hour PAV conditions for the 0%, 5% and 7.5% sterol levels for both the Mayan Crude based Asphalto 64-22 and the Canadian Crude based PG 64-22. The Asphalto 64-22 which exhibited significant decrease in ΔTc with aging was significantly improved with the addition of the sterol additive and again a dose response effect was seen for the Asphalto 64-22 binder although the greatest impact was seen at the 60 hour PAV aged condition. The Canadian Crude based PG 64-22, which does not have a serious problem with negative values of ΔTc also exhibited some improvement in ΔTc with aging, but the effect was much less pronounced.

This comparative analysis of the impact of the sterol additive on asphalt binder binders which exhibit marked differences due to aging suggest that the benefits of the sterol additive are most likely to be of value in asphalt binders that exhibit these large decreases in ΔTc with aging.

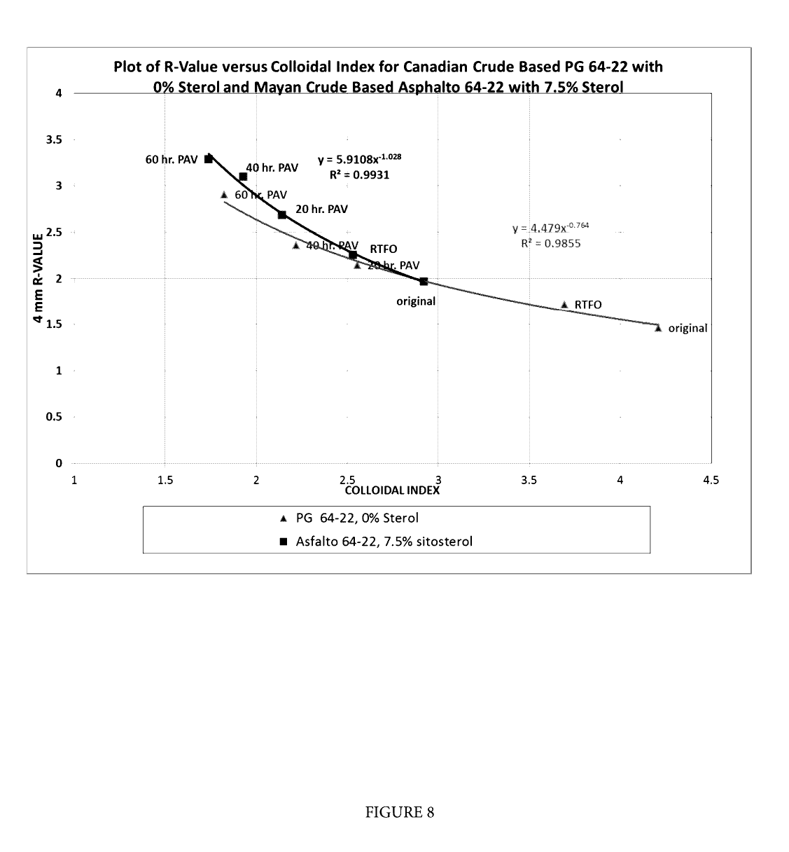

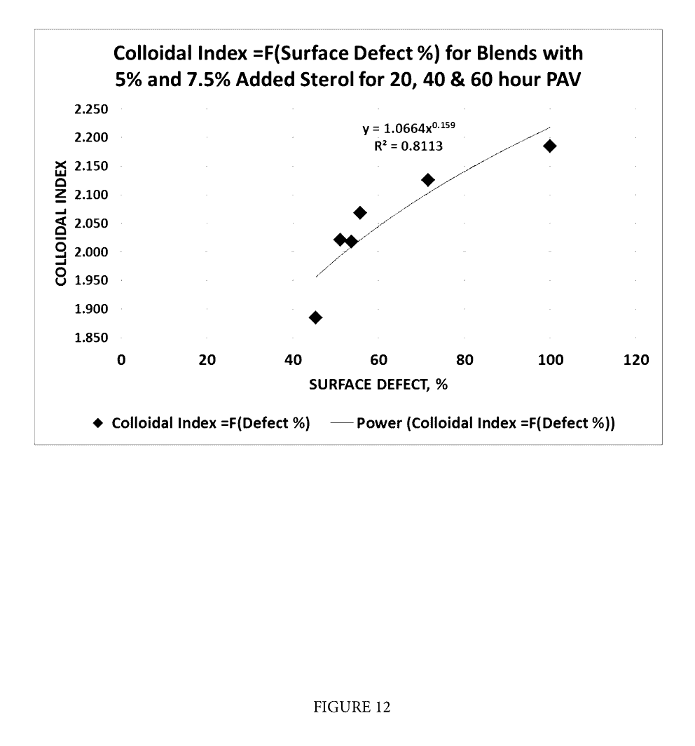

FIG. 12 is a plot of R-Value versus Colloidal Index for the Canadian Crude based PG 64-22. The 0% sterol blend showed higher R-Values compared to the 5% and 7.5% blends. However the difference between the sterol blends and the control 0% blend is about half the difference for the Asphalto 64-22. FIG. 8 showed that through a comparison of R-value versus Colloidal Index for the Asphalto 64-22 with 7.5% sterol and the PG 64-22 with no additive that it is possible to move an asphalt binder with severe aging issues closer to the characteristics of an asphalt binder with minimal aging issues.

### Example 6

Atomic Force Microscopy (AFM) analysis was performed on samples MN1-4, MN1-4+5% Sterol and MN1-4+7.5% Sterol, which data has already been discussed in terms projected improved pavement performance on Olmsted, MN CTH 112 as in Example 5.

Atomic force microscopy (AFM) was performed at Arkansas State University in Jonesboro Arkansas under the direction of Dr. Zahid Hossain. Binders were prepared for AFM by applying a small bead of asphalt to the imaging substrate. The bead was scraped against the surface of the substrate and the film heated to allow the film surface to level.

AFM images were captured at room temperature on a microscope. Both topographic and friction images were obtained after the asphalt films had been annealed 72 h to 96 h at room temperature. The basics of AFM and the origin of the topographic and friction signals were described before (Overney et al. Friction Measurements on Phase-Separated Thin Films with a Modified Atomic Force Microscope”, Nature, 1992, 359, 133-135 (1992), Muhlen et al. Introduction to Atomic Force Microscopy and its Application to the Study of Lipid Nanoparticles”, Chapter 7 in Particle and Surface Characterization Methods, R. H. Muller and W. Mehnert Eds, Medpharm Scientific Pub, Stuttgart, 1997 (1992); and Takano et al. Chemical and Biochemical Analysis Using Scanning Force Microscopy”, Chemical Reviews 1999, 99, 2845-2890 (1999)). The topographic images reveal vertical elevations and declinations associated to surface features, whereas the friction image allows for the differentiation of surface material based on changes in elastic or adhesive properties. It thus reveals changes in surface composition, without revealing the nature of the change. All the microphotographs show a 20 □m×20 □m region unless otherwise indicated.

The AFM data generated was analyzed for surface characteristics and it was discovered that as the binders were aged with the different levels of sterol there was an increase in the amount of what we have termed surface defects that developed in the material being imaged.

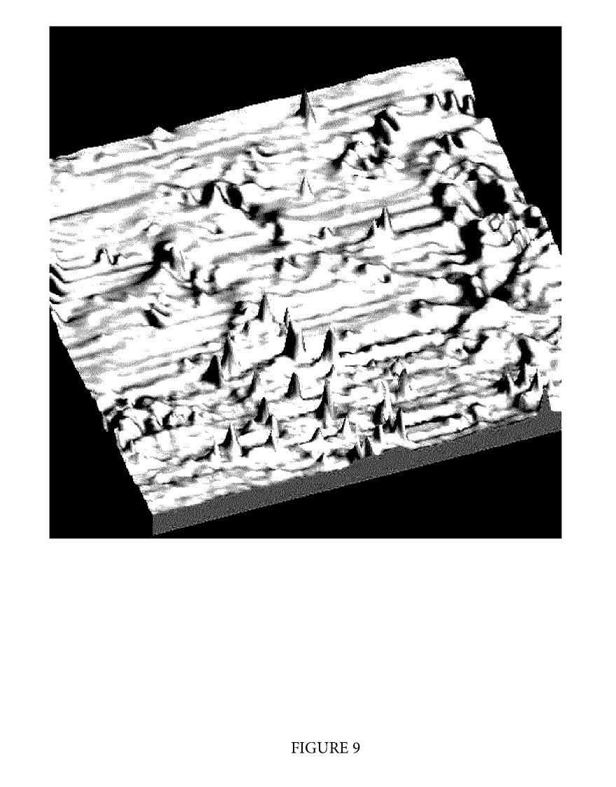

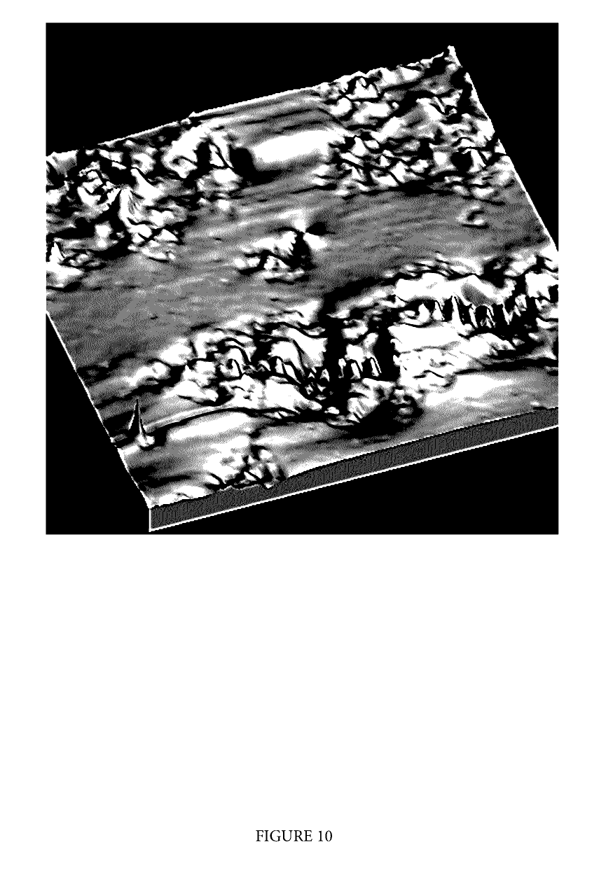

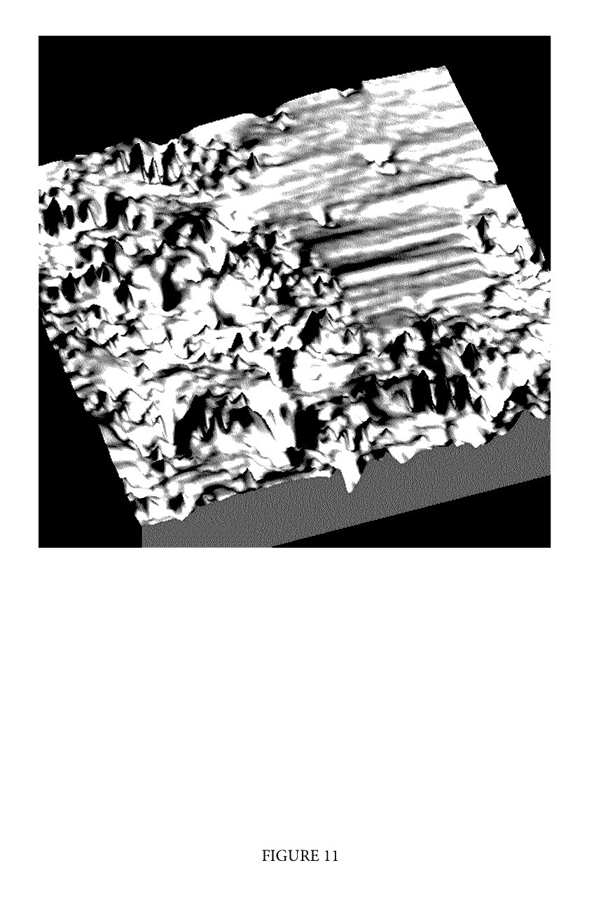

FIGS. 9, 10, 11 all of which are for 60 hour PAV aged samples of the respective samples, just visually it is clear that extent to which the surface has become more rough or textured has increased as the images move from 0% to 5% to 7.5% sterol. The table below is summary of the surface roughness, expressed as average roughness over the image surface, the average height of the roughness extending out of the surface of the sample, the defect area (i.e. the non-smooth plane of the sample) expressed in μm2 and the defect area expressed as a percent keeping in mind that the area of each image is 400 μm2.

FIG. 12 is a plot of the Colloidal Index plotted versus the surface defects expressed as a percent for just the 5% and 7.5% sterol blends for the 20, 40 and 60 hour PAV residues. This approach was taken because when all aging conditions were included there was a very poor fit of data which seemed to be related to the fact that there was little change in the Colloidal Index for the unaged and RTFO condition. By focusing on the impact of the sterol additive after significant aging a relationship between the chemical compositional changes captured by the Iatroscan test and the changes occurring at the molecular level captured by the AFM were drawn out. As the area occupied by the surface defects decreases the Colloidal Index decreases which represents a more aged material. Table 14 shows that as the binders age the general trend is for the defect area to decrease. We interpret this to mean that initially the components that result in binder degradation are agglomerated and as they age these components oxidize resulting in chemical changes that cause the Colloidal Index to decrease. Namely these changes are increase in asphaltenes and decrease in cyclics. Also the chemical changes result in reduction in the ability of the binder to relax stresses and this is manifested as increases in R-Value and decreases in ΔTc. As discussed above the presence of the sterol additive appears to remove those components that cause property degradation and render them less effective than they would otherwise be. As the data shows this retardation of degradation is not a permanent change in the binder but can substantially extend the time before the binder will reach the state of degradation were the sterol not present.

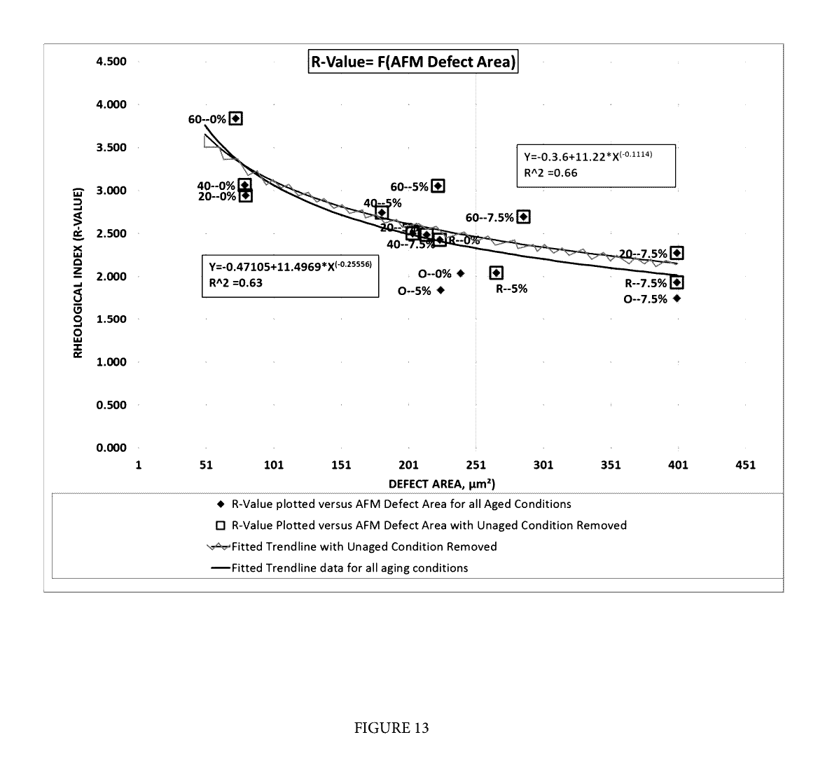

FIG. 13 shows two plots of R-Value as a function of the Defect area in the AFM images. The diamond symbols are for all the binder aging conditions and the open square symbols are the data with the unaged condition data removed. The curve fit for these data are reasonable showing that as the defect area is reduced the R-Value increases and thus representing a more aged condition. Note the 20, 40 and 60 hour PAV results for the MN1-4 sample with no sterol are on the upper left side of which is the most aged binder region as the R-Value shows. Also the three least aged 7.5% sterol blends are on the lower right side of the plot which is least aged condition based on R-Value. Leaving the unaged or original binder data out of the plot makes some sense in that as the data plot shows the R-value for those three samples in the unaged condition are essentially the same as no oxidation has taken place with these samples.

Another interpretation of the data shown in FIG. 13 is that for the 5% sterol blend there is not much change with aging and therefore the 5% addition represents a blend that can be aged through 60 hours moderate increases in R-Value. The 7.5% sterol addition seems to demonstrate that in the early stages of aging the sterol actually results in an improvement to the binder by moving the R-Value to a more favorable position. For the 7.5% sterol blend it takes aging beyond the 20 hour PAV to move the R-Value back up the fitted data line to the condition where the 0% and 5% sterol blends began.

### Example 7

20% shingle binder was added to the PG 52-34, 5% Sterol blend and, 2.5% of a bio derived oil were added. The blends were aged for up to 40 hours in the PAV and the R-Value, low temperature stiffness grade, m-value grade and ΔTc were determined as described previously.

The addition of the bio-derived oil can preserve the low temperature properties of the aged binder to nearly the same condition as the binder sample without any shingle binder added. The presence of the shingle binder in the blend resulted in more negative ΔTc values after 20 and 40 hours of aging, but the ΔTc values were still acceptable and not close to the generally accepted point of potential performance damage of a ΔTc=−5.0° C. The low temperature grade of both binders after 20 hours of PAV aging was still a −34 grade and after 40 hours of PAV aging is approximately −33.5° for both blends. The data is shown in Table 16.

Some additional non-limiting embodiments are provided below to further exemplify the present disclosure:
1. An asphalt binder paving composition comprising aggregate, virgin asphalt binder, reclaimed asphalt binder material comprising reclaimed asphalt pavement (RAP), reclaimed asphalt shingles (RAS) or combinations of both, a triterpenoid, and a softening agent, wherein the asphalt binder paving composition is free of cyclic organic compositions that contain esters or ester blends, and a sterol content in the rage of 0.5 to 15 wt. % of the virgin asphalt binder.
2. An asphalt binder composition comprising virgin asphalt binder, reclaimed asphalt binder material comprising reclaimed asphalt pavement (RAP), reclaimed asphalt shingles (RAS) or combinations of both, a triterpenoid, and a softening agent, wherein the asphalt binder composition is free of cyclic organic compositions that contain esters or ester blends, and a sterol content is within the rage of 0.5 to 15 wt. % of the virgin asphalt binder.
3. A method for retarding oxidative aging of the asphalt binder, which method comprises adding one of more triterpenoid or a triterpenoid blends to a bituminous or asphalt binder composition, wherein the triterpenoid or triterpenoid blend does not contain an ester or an ester blend, and wherein the triterpenoid or triterpenoid blend is used in the composition in a range of 0.5 to 15 wt. %, wherein the triterpenoid additive is present within the range of 1 to 10 wt. %, or within the range of 1 to 3 wt. % of the virgin asphalt binder.
4. A method for reusing reclaimed asphalt binder for asphalt pavement production, which method comprises the use of a triterpenoid or a triterpenoid blend as an additive to bituminous or asphalt binder mixture without the use of an ester or an ester blend, and wherein the triterpenoid additive is present within the range of 0.5 to 15 wt. %., 1 to 10 wt. %., or 1 to 3 wt. % of the virgin asphalt binder.
5. A method for applying a road pavement surface which method incorporates the use of asphalt binder composition of any of the preceding embodiments, wherein the asphalt binder composition of any of the preceding embodiments are prepared, mixed, applied to a base surface, and compacted.
6. The composition and methods of any of the preceding embodiments wherein the triterpenoid is a sterol.
7. The composition and methods of any of the preceding embodiments wherein the triterpenoid is a stanol.
8. The composition and methods of any of the preceding embodiments wherein the triterpenoid is a plant sterol.
9. The composition and methods of any of the preceding embodiments wherein the triterpenoid is a plant stanol.
10. The composition and methods of any of the preceding embodiments wherein the reclaimed asphalt binder material is RAP.
11. The composition and methods of any of the preceding embodiments wherein the reclaimed asphalt binder material is RAS.
12. The composition and methods of any of the preceding embodiments wherein sterol content is in a range of 1 to 15 wt. % of the virgin asphalt binder.
13. The composition and methods of any of the preceding embodiments wherein the asphalt binder compositions comprising reclaimed asphalt shingles (RAS) at a binder replacement level 1% and greater.
14. The composition and methods of any of the preceding embodiments wherein the asphalt binder compositions comprising reclaimed asphalt pavement (RAP) at binder replacement levels 20% and greater.
15. The composition and methods of any of the preceding embodiments wherein the asphalt binder compositions comprising reclaimed asphalt pavement (RAP) and reclaimed asphalt shingles (RAS) used in combination at RAP binder replacement levels of 10% and greater and RAS binder replacement levels of 1% and greater.
16. The composition and methods of any of the preceding embodiments wherein the asphalt binder compositions comprising asphalt binder extracted and recovered from post-consumer waste shingles at levels of 5% by weight and greater.
17. The composition and methods of any of the preceding embodiments wherein the asphalt binder compositions comprising asphalt binder extracted from manufacture's waste shingles at levels of 5% by weight and greater.
18. The composition and methods of any of the preceding embodiments wherein the asphalt binder compositions comprising oxidized asphalt binders meeting ASTM specification D312 for Type II, Type III, Type IV and coating asphalt binder at levels of 5% by weight and greater.
19. The composition and methods of any of the preceding embodiments wherein the asphalt binder compositions comprising extracted and recovered RAP at levels of 10% by weight and greater.
20. The composition and methods of any of the preceding embodiments wherein the asphalt binder compositions comprising re-refined engine oil bottoms at levels of 3% and higher by weight or volume percent.
21. The composition and methods of any of the preceding embodiments wherein the asphalt binder compositions comprising paraffinic oils at levels of 1% and higher by weight or volume percent.
22. The composition and methods of any of the preceding embodiments wherein the asphalt binder paving compositions comprising re-refined engine oil bottoms at levels of 1% and higher by weight or volume percent.
23. The composition and methods of any of the preceding embodiments wherein the asphalt binder paving compositions comprising paraffinic oils at levels of 1% and higher by weight or volume percent.
24. An asphalt binder paving composition comprising aggregate, virgin asphalt binder, reclaimed asphalt binder material comprising reclaimed asphalt pavement (RAP), reclaimed asphalt shingles (RAS) or combinations of both, a triterpenoid, and a softening agent, wherein the asphalt binder paving composition is free of cyclic organic compositions that contain esters or ester blends, and a sterol content in the rage of 0.5 to 15 wt. % of the virgin asphalt binder.
25. An asphalt binder composition comprising virgin asphalt binder, reclaimed asphalt binder material comprising reclaimed asphalt pavement (RAP), reclaimed asphalt shingles (RAS) or combinations of both, a triterpenoid, and a softening agent, wherein the asphalt binder composition is free of cyclic organic compositions that contain esters or ester blends, and a sterol content is within the rage of 0.5 to 15 wt. % of the virgin asphalt binder.
26. A method for retarding oxidative aging of the asphalt binder, which method comprises adding one of more triterpenoid or a triterpenoid blends to a bituminous or asphalt binder composition, wherein the triterpenoid or triterpenoid blend does not contain an ester or an ester blend, and wherein the triterpenoid or triterpenoid blend is used in the composition in a range of 0.5 to 15 wt. %, wherein the triterpenoid additive is present within the range of 1 to 10 wt. %, or within the range of 1 to 3 wt. % of the virgin asphalt binder.
27. A method for reusing reclaimed asphalt binder for asphalt binder pavement production, which method comprises the use of a triterpenoid or a triterpenoid blend as an additive to bituminous or asphalt binder mixture without the use of an ester or an ester blend, and wherein the triterpenoid additive is present within the range of 0.5 to 15 wt. %., 1 to 10 wt. %., or 1 to 3 wt. % of the virgin asphalt binder.
28. A method for applying a road pavement surface which method incorporates the use of asphalt binder composition of any of the preceding embodiments, wherein the asphalt binder composition of any of the preceding embodiments are prepared, mixed, applied to a base surface, and compacted.
29. The composition and methods of any of the preceding embodiments wherein the triterpenoid is a sterol.
30. The composition and methods of any of the preceding embodiments wherein the triterpenoid is a stanol.
31. The composition and methods of any of the preceding embodiments wherein the triterpenoid is a plant sterol.
32. The composition and methods of any of the preceding embodiments wherein the triterpenoid is a plant stanol.
33. The composition and methods of any of the preceding embodiments wherein the reclaimed asphalt binder material is RAP.
34. The composition and methods of any of the preceding embodiments wherein the reclaimed asphalt binder material is RAS.
35. The composition and methods of any of the preceding embodiments wherein sterol content is in a range of 1 to 15 wt. % of the virgin asphalt binder.
36. The composition and methods of any of the preceding embodiments wherein the asphalt binder compositions comprising reclaimed asphalt shingles (RAS) at a binder replacement level 1% and greater.
37. The composition and methods of any of the preceding embodiments wherein the asphalt binder compositions comprising reclaimed asphalt pavement (RAP) at binder replacement levels 20% and greater.
38. The composition and methods of any of the preceding embodiments wherein the asphalt binder compositions comprising reclaimed asphalt pavement (RAP) and reclaimed asphalt shingles (RAS) used in combination at RAP binder replacement levels of 10% and greater and RAS binder replacement levels of 1% and greater.
39. The composition and methods of any of the preceding embodiments wherein the asphalt binder compositions comprising asphalt binder extracted and recovered from post-consumer waste shingles at levels of 5% by weight and greater.
40. The composition and methods of any of the preceding embodiments wherein the asphalt binder compositions comprising asphalt binder extracted from manufacture's waste shingles at levels of 5% by weight and greater.
41. The composition and methods of any of the preceding embodiments wherein the asphalt binder compositions comprising oxidized asphalt binders meeting ASTM specification D312 for Type II, Type III, Type IV and coating asphalt binder at levels of 5% by weight and greater.
42. The composition and methods of any of the preceding embodiments wherein the asphalt binder compositions comprising extracted and recovered RAP at levels of 10% by weight and greater.
43. The composition and methods of any of the preceding embodiments wherein the asphalt binder compositions comprising re-refined engine oil bottoms at levels of 3% and higher by weight or volume percent.
44. The composition and methods of any of the preceding embodiments wherein the asphalt binder compositions comprising paraffinic oils at levels of 1% and higher by weight or volume percent.
45. The composition and methods of any of the preceding embodiments wherein the asphalt binder paving compositions comprising re-refined engine oil bottoms at levels of 1% and higher by weight or volume percent.
46. The composition and methods of any of the preceding embodiments wherein the asphalt binder paving compositions comprising paraffinic oils at levels of 1% and higher by weight or volume percent.

Some additional non-limiting embodiments are further provided below to further exemplify the present disclosure:
1. A method to identity at least one deleterious component present in an asphalt binder comprising measuring defect areas in an Atomic Force Microscopy image.
2. The method according to embodiment 1, wherein the deleterious component is Re-refined Engine Oil Bottoms.
3. The method according to embodiment 1, wherein the deleterious component is Vacuum Tower Asphalt Extender.
4. The method according to embodiment 1, wherein the deleterious component is any drain oil product or waste engine oil material with or without post-consumer processing.
5 The method according to embodiment 1, wherein the deleterious component is paraffinic processing oil.
6. The method according to embodiment 1, wherein the deleterious component is lubricating base oil.
7. The method according to embodiment 1, wherein the deleterious component is asphalt binder extracted from a paving mixture containing RAP and the RAP is present in an asphalt binder in an amount ranging from 0.1% to 100% of the paving mixture.
8. The method according to embodiment 1, wherein the deleterious component is asphalt binder extracted from a paving mixture containing RAS and the RAS is present in a binder replacement amount of 0.1% to 50%.
9. The method according to embodiment 1, wherein the deleterious material is asphalt binder extracted from a paving mixture containing RAP and RAS, and wherein a combination of RAP and RAS is present in an asphalt binder in an amount of 0.1% to 100%.
10. The method according to embodiment 1, wherein deleterious material is naturally occurring in an asphalt binder and not resulting from any materials added after the asphalt binder has been produced.
11. A method of using Atomic Force Microscopy comprising identity asphalt binders with high levels of defect areas as it ages which are associated with deleterious asphalt binder components.
12. A method of using Atomic Force Microscopy comprising screening additives suitable for preventing deleterious binder components from causing high levels of defect areas in bulk asphalt binder as it ages.
13. The method according to embodiments 11 or 12, wherein aging is un-accelerated aging, Rolling Thin Film Oven aging (RTFO aged), 20 hours of PAV aging, 40 hours of PAV aging, additional multiples of 20 hours of PAV aging after 40 hours of PAV aging.
14. The method according to embodiment 13, wherein amounts of defect areas in the asphalt binder are determined after multiple aging conditions.
15. A method of using Atomic Force Microscopy to identity at least one deleterious component present in an aged asphalt binder sample comprising measuring defect areas in an Atomic Force Microscopy image.
16. The method according embodiment 15, wherein the aged asphalt binder sample is extracted from the upper ½ inch of a pavement sample obtained from a road
17. The method according embodiment 15, wherein the aged asphalt binder sample is a pavement sample has been in place from 1 day to 10 years inclusive.
18. The method according embodiment 15, wherein the aged asphalt binder is extracted from any depth of a pavement layer including the full pavement layer.
19. The method according embodiment 15, wherein the aged asphalt binder sample is taken from a freshly product bituminous mixture prior to paving.
20. An asphalt binder comprising 1 to 10 wt % triterpenoids and 1 to 8% wt % bio-derived or petroleum-derived oil based on total asphalt binder weight.
21. The asphalt binder of embodiment 20, wherein the asphalt binder is a Performance Graded binder with or without polymer modification
22. The asphalt binder of embodiment 20, wherein the asphalt binder contains 0.1 to 2 wt % polyphosphoric acid based on total asphalt binder weight.
23. The asphalt binder of embodiment 20, wherein the asphalt binder containing the sterol and bio-derived or petroleum-derived oil is blended with recovered asphalt from tear off shingles or manufacturer's waste shingles.
24. The asphalt binder of embodiment 23, wherein the shingles are tear off shingles.
25. The asphalt binder of embodiment 43, wherein the shingles are from manufacturer's waste shingles.
26. The asphalt binder of embodiment 20, wherein the asphalt binder containing the sterol and bio-derived or petroleum-derived oil is used to produce a paving mixture containing 10 to70 wt % RAP based on weight of the paving mixture
27. The asphalt binder of embodiment 20, wherein the asphalt binder containing the sterol and bio derived or petroleum derived oil is used to produce a paving mixture containing 1 to 7 wt % RAS based on weight of the paving mixture.

1. An asphalt binder composition comprising virgin asphalt binder, reclaimed asphalt binder material comprising reclaimed asphalt pavement (RAP), reclaimed asphalt shingles (RAS) or combinations of both and 0.5 to 15 wt. % of an anti-aging additive based on the virgin asphalt binder.

2. The asphalt binder composition of claim 1, wherein the anti-aging additive is 1 to 10 wt. %, or 1 to 3 wt. % of the virgin asphalt binder.

3. The asphalt binder composition of claim 1, wherein the anti-aging additive comprises a triterpenoid or triterpenoid blend.

4. The asphalt binder composition of claim 3, wherein the triterpenoid comprises a plant sterol or plant stanol.

5. The asphalt binder composition of claim 1, further comprising a softening agent.

6. The asphalt binder composition of claim 5, wherein the softening agent comprises a re-refined engine oil bottoms.

7. The asphalt binder composition of claim 1, further comprising aggregate.

8. The asphalt binder composition of claim 1, wherein the asphalt binder composition provides a ΔTc of −5.0 or greater.

9. The asphalt binder composition of claim 1, wherein the restorative additive is present in an amount effective to provide a less negative ΔTc value after aging the asphalt binder composition compared to a similarly-aged binder without the restorative additive.

10. A paved surface comprising the asphalt binder composition of claim 1.

11. A method for slowing the aging or restoring aged asphalt binder comprising:
adding an anti-aging additive to an asphalt binder composition, wherein the asphalt binder composition comprises a virgin asphalt binder, reclaimed asphalt binder material comprising reclaimed asphalt pavement (RAP), reclaimed asphalt shingles (RAS) or combinations of both and 0.5 to 15 wt. % of an anti-aging additive based on the virgin asphalt binder.

12. The method of claim 12, wherein the anti-aging additive is 1 to 10 wt. %, or 1 to 3 wt. % of the virgin asphalt binder.

13. A method to identity at least one deleterious component present in an asphalt binder comprising measuring defect areas in an Atomic Force Microscopy image.

14. The method according to claim 13, wherein the deleterious component is asphalt binder extracted from a paving mixture containing Reclaimed Asphalt Pavement (RAP) and the RAP is present in an asphalt binder in an amount ranging from 0.1% to 100% of the paving mixture.

15. The method according to claim 13, wherein the deleterious component is asphalt binder extracted from a paving mixture containing Reclaimed Asphalt Shingles (RAS) and the RAS is present in a binder replacement amount of 0.1% to 50%.
